(19) United States
(12) Patent Application Publication
(10) Pub. No.: US 2023/0274371 A1
(43) Pub. Date: Aug. 31, 2023

(54) DATA FERRET

(71) Applicant: Steady Platform LLC, Atlanta, GA (US)

(72) Inventors: Marcel Crudele, Atlanta, GA (US); Jason Robinson, Atlanta, GA (US); Nathan Crockett, Atlanta, GA (US); Andrew Toloff, Atlanta, GA (US); Tyler Howard, Atlanta, GA (US); Raja Surireddy, Atlanta, GA (US)

(21) Appl. No.: 18/113,137

(22) Filed: Feb. 23, 2023

Related U.S. Application Data
(60) Provisional application No. 63/313,810, filed on Feb. 25, 2022.

(51) Int. Cl. G06Q 40/12; G06Q 40/06; G06Q 20/02

(52) U.S. Cl. CPC G06Q 40/12; G06Q 40/06; G06Q 20/02

(57) ABSTRACT

Provided are systems and methods for identifying unclaimed sources of funds such as employers, gig opportunities, businesses, and the like. The process can be used as part of a larger process that may also include fraud checks, deduplication of data, verification of users, analytical insight, and the like. In one example, a method may include establishing a communication channel with a third-party data source via an application programming interface (API), ingesting data records of the user from the third-party data source via the established communication channel based on an account identifier, identifying an unclaimed source of income based on a data value stored within the ingested data records, and displaying an identifier of the unclaimed source of income and an input mechanism which is configured to confirm the identified unclaimed source of income.

### CROSS-REFERENCE

The present invention is a non-provisional application claiming priority to provisional application No. 63/313,810 which was filed on Feb. 25, 2022 and entitled “DATA FERRET”, the entire content of which is incorporated by reference herein in its entirety.

### BACKGROUND

Income verification is commonly performed by financial services providers during the ordinary course of business. Income verification is also performed in many other service providers and governmental agencies, including benefit administration (e.g., unemployment, social security, grants, etc.), rental agreements, automobile purchases, and the like. A traditional income verification process relies on the user inputting their relevant financial and other details into a user interface and the host verifying such data against previously stored data in the back-end. The verification process is typically limited to the data submitted by a user. However, there are occasions where a user does not provide all of their income sources (e.g., forgot, intent to deceive, etc.). In such a scenario, it is difficult for the host to detect such missing income sources or accurately verify the amount of income earned by the user. Accordingly, a decision can be made without all of the necessary information, which can impact the user, the provider, and/or the taxpaying public, in the case of benefit administration.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIGS. 1A-1B are diagrams illustrating processes of a host platform identifying and confirming unclaimed or otherwise unreported income sources in accordance with example embodiments.

FIGS. 2A-2C are diagrams illustrating a process of identifying an unclaimed or otherwise unreported income source in accordance with example embodiments.

FIGS. 3A-3C are diagrams illustrating a process of verifying a user based on personally-identifiable information (PII) in accordance with example embodiments.

FIGS. 4A-4C are diagrams illustrating a process of reconciling, deduplicating, and verifying income-based records in accordance with example embodiments.

FIGS. 5A-5C are diagrams illustrating a process of enhancing and thus enriching transaction records in accordance with example embodiments.

FIGS. 6A-6B are diagrams illustrating processes of reconciling transaction records in accordance with example embodiments.

FIG. 7 is a diagram illustrating a method of discovering and confirming additional sources of income data in accordance with an example embodiment.

FIG. 8 is a diagram illustrating an example of a computing system for use in any of the examples described herein.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, details are set forth to provide a reader with a thorough understanding of various example embodiments. It should be appreciated that modifications to the embodiments will be readily apparent to those skilled in the art, and generic principles defined herein may be applied to other embodiments and applications without departing from the spirit and scope of the disclosure. Moreover, in the following description, numerous details are set forth as an explanation. However, one of ordinary skill in the art should understand that embodiments may be practiced without the use of these specific details. In other instances, well-known structures and processes are not shown or described so as not to obscure the description with unnecessary detail. Thus, the present disclosure is not intended to be limited to the embodiments shown, but is to be accorded the widest scope consistent with the principles and features disclosed herein.

The example embodiments are directed to a host platform that hosts a software application referred to herein as a “data ferret”. The data ferret can connect to a user's bank accounts, payroll accounts, or other financial services and analyze transaction and other financial records from the user's accounts. Here, the data ferret can identify sources of income from within the transaction and other financial records and determine whether such sources of income have already been specified by the user. If not, the data ferret can output a verification user interface on the user's device with an identification of each unclaimed income source and an input mechanism for “confirming” that each source of income is correct. The data ferret can also use available data to determine if there are missing sources of financial data that the user has not connected to, but that the user should connect to for completeness. Methods of this type of identification include, but are not limited to, leveraging known employer or financial institution information from data partners (i.e., a “3^{rd} party data seed” or “third party data seed”), using forensics of existing transaction information to identify missing accounts via transfers of funds, etc. Furthermore, the data ferret can launch other processes based on the additional sources of income to determine additional verifications of the user including identify verification, income verification, reconciliation and deduplication, and the like. It should be appreciated that the data ferret can maintain a growing list of income sources, to determine what ground has been covered and what is remaining to iteratively explore, until some stopping condition is achieved (e.g., no more unclaimed accounts or deposit sources remain for further exploration). A clarifying example of stopping conditions is discussed in relation to an example embodiment below.

When an organization, whether governmental, social, business, or otherwise, wants to distribute basic income, guaranteed income, or any other type of cash benefits program funds to individuals, several obstacles exist. Some of the obstacles include verifying whether a participant in a benefits program is eligible to receive such a benefit. In other words, does the person satisfy the criteria for the benefit, which may include restrictions on income, assets, property values, debts, and the like, based on the information provided and/or gathered.

The data ferret can be beneficial for programs that rely on users to provide an accurate account of their income such as benefit administration, home loans, car loans, personal loans, rental agreements, and the like. For example, the data ferret can find and confirm intentionally “hidden” sources of income. Furthermore, the data ferret can find and confirm “forgotten” or otherwise unknown sources of income that the user has forgotten about or that the user is not aware of. The data ferret can be a precursor step to the benefit administration processes described in U.S. patent application Ser. No. 17/864,589, filed on Jul. 14, 2022, in the United States Patent and Trademark Office, which is fully incorporated herein by reference for all purposes.

The host platform may also participate and manage the disbursement of funds/benefits as part of the benefit administration process. For example, the host platform may include a scheduler that can schedule payments to a user at future times and trigger those payments at the future times. Furthermore, proof of such payments and proof of confirmation of such payments (e.g., by a financial institution or the person themselves) may be stored in an auditable and immutable trail on a blockchain ledger or other distributed environment. The host platform provides a mechanism for administering basic income, guaranteed income, and/or any other cash benefits programs to individuals in an automated and verifiable manner.

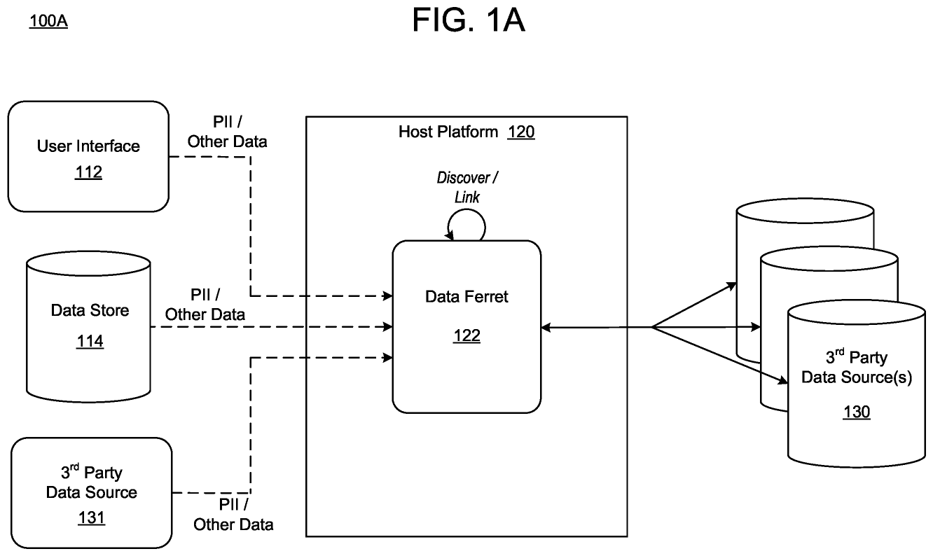

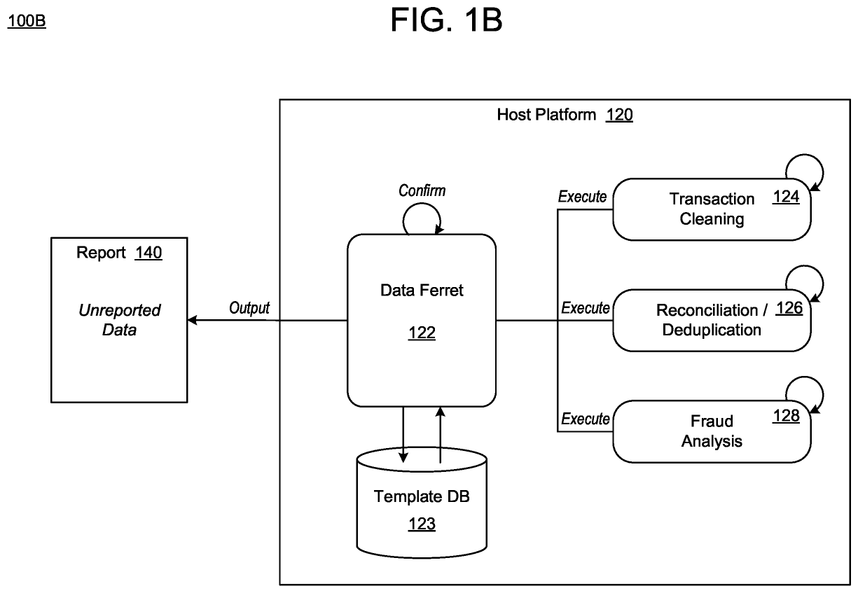

FIG. 1A illustrates a process 100A of a host platform 120 identifying unclaimed income sources in accordance with example embodiments. Referring to FIG. 1A, the host platform 120 may be a host system such as a cloud platform, a web server, a database, a blockchain network, a combination of systems, and the like. The host platform 120 hosts a data ferret 122 according to various embodiments. The data ferret 122 is a software program such as a service, microservice, application, etc., which is able to interact with a user via a user interface 112 and query third-party data stores 130 for additional user data over a computer network, for example, using structured query language (SQL) queries, or the like. The third-party data stores 130 may include financial services, or the like, which collect and accumulate financial or other information about users such as known employers or financial institutions associated with the user. Here, a user can “authorize” the data ferret 122 to access their data held at the third-party data sources 130 if such authorization is required; however, the third-party data sources 130 and the associated data might be available without such authorization.

As with the supplemental information that can be retrieved from querying the third-party data sources 130, similar information may be proactively transmitted to the data ferret 122 by the third-party data source 131 without a query. An example of this might be the case of a partner that has requested income verification for a user while also providing the data ferret 122 with supplemental information that is already known, such as employers or financial institutions associated with the user.

Additionally, the data ferret 122 can also ingest data values from the user via the user interface 112 and from the local data store 114 that includes records that have been ingested previously. In this example, a user may input account numbers and/or routing numbers, login credentials, or the like, of bank accounts, employer accounts (e.g., gig employers, etc.), payroll company accounts, credit accounts, etc., held by the third-party data sources 130 such as banks, credit agencies, payroll processors, employers/organizations, institutions, and the like, into one or more input fields displayed within the user interface 112 and submit them to the host platform 120 by clicking on a button or the like within the user interface 112 on a user device (not shown). For example, the user device and the host platform 120 may be connected via the Internet, and the user interface 112 may send the information via an HTTP message, an application programming interface (API) call, or the like. When the account identifiers are transmitted, a response containing relevant account information and the like may be received and stored in the data store 114.

In response to receiving the account information, the host platform 120 may register/authenticate itself with one or more of the third-party data sources 130 where the accounts/user accounts are held/issued. For example, the host platform 120 may perform a remote authentication protocol/handshake with one or more of the third-party data sources based on access credentials of the user. In other words, the host platform 120 may receive authorization from the user to access the user's account data from the third-party data sources 130. These accounts provide the host platform with financial transaction records of the user. In some embodiments, the system may connect to multiple third-party systems (e.g., payroll and user's bank account) to create a unique mesh of partially-overlapping data sets that can be combined into one larger data set and analyzed.

It should also be appreciated that the user may manually upload data such as documents, bank statements, account credentials, and the like, in a format such as a pdf file, word processor file, spreadsheet, XML file, JSON file, etc. via the user interface 112. These documents may also be stored in and retrieved from the data store 114. Furthermore, optical character recognition (OCR) may be performed on any documents, files, bank statements, etc. obtained by the host platform 120 to extract attributes from such documents and files.

The authentication process may include one or more API calls being made to each of the different third-party data sources 130 (e.g., bank, payroll, employer, etc.) via the host platform 120 to establish a secure HTTP communication channel. For example, the data ferret 122 may be embedded or otherwise provisioned with access credentials of the user for accessing the third-party data sources 130. The data ferret 122 may use these embedded, provisioned, and/or otherwise securely stored credentials to establish or otherwise authenticate itself with the third-party data sources 130 as an agent of the user. Each authenticated channel may be established through a sequence of HTTP communications between the host platform 120 and the various servers. The result can be a plurality of web sessions between the host platform 120 and a plurality of servers, respectively. The host platform 120 can request information/retrieve information from any of the servers, for example, via HTTP requests, API calls, and the like. In response, the user data can be transmitted from the servers to the host platform 120 where it can be combined in the data mesh for further processing.

According to various embodiments, the data ferret 122 can receive an identifier of a bank account from a user via the user interface 112. In addition, the data ferret 122 may also receive identifiers of one or more claimed sources of income. In response, the data ferret 122 can access the third-party data sources 130 that issued the bank account, and establish a communication channel between the data ferret 122 and the third-party data sources 130 that issued the bank account. Here, the data ferret 122 may use the access credentials of the user with the third-party data sources 130. As another example, the data ferret 122 may receive its own credentials provisioned by the third-party data sources 130.

Once the communication channel is established, the data ferret 122 can pull transaction records from the user's bank account including bank statements, transaction records, balance information, payment history, and the like. The data ferret 122 can search through the records and identify any sources of income based on values stored within the records, including raw transaction strings stored within financial transaction records that are created by financial services providers as a result of payments being processed. Transaction records and strings can include names, variables, words, other string values, characters, etc., which can be identified as being related to a particular income source. For example, within a given financial transaction record, a transaction string associated with a particular transaction may include a value “ACME TECH”, which the data ferret 122 may interpret as a particular income source named “ACME Technologies, Inc.”, from which the user receives either W-2 or 1099 income on some basis. In addition to finding income sources, the data ferret 122 may also confirm any unclaimed income sources with the user, for example, via the user interface 112.

FIG. 1B illustrates a process 100B of the host platform 120 performing additional processes with the unclaimed income identification and confirmation in accordance with example embodiments. Referring to FIG. 1B, the data ferret 122 may trigger additional steps on the input transaction strings from the third-party data sources 130 to “clean” the transaction strings via a transaction string cleaning process 124. The transaction string cleaning process 124 may identify missing values such as “counterparties” that are the payors of a credit to the user. These counterparties can be considered sources of income. In some cases, the data ferret 122 may require a continual payment relationship for the source to be considered a source of income. For example, one payment from a business may be for something unrelated to income. However, multiple payments spaced out in periodic relationships (e.g. weekly, biweekly, monthly, on specific days within time periods, etc.) over time may indicate a continued income-earning relationship. Additionally, in some embodiments, the string cleaning process 124 can remove or otherwise extract transient values, geographic locations, and other upstream financial institution identifiers from the raw transaction strings to facilitate income source identification. Moreover, in some embodiments, the string cleaning process 124 can assign unique identifiers to components within the raw transaction string, enabling easier cross referencing to a collection or data store of standardized transaction string components or relevant entities representing counterparties. Thus, the transaction string cleaning process 124 can “enhance” the transaction strings prior to the data ferret 122 performing the unclaimed income source identification process.

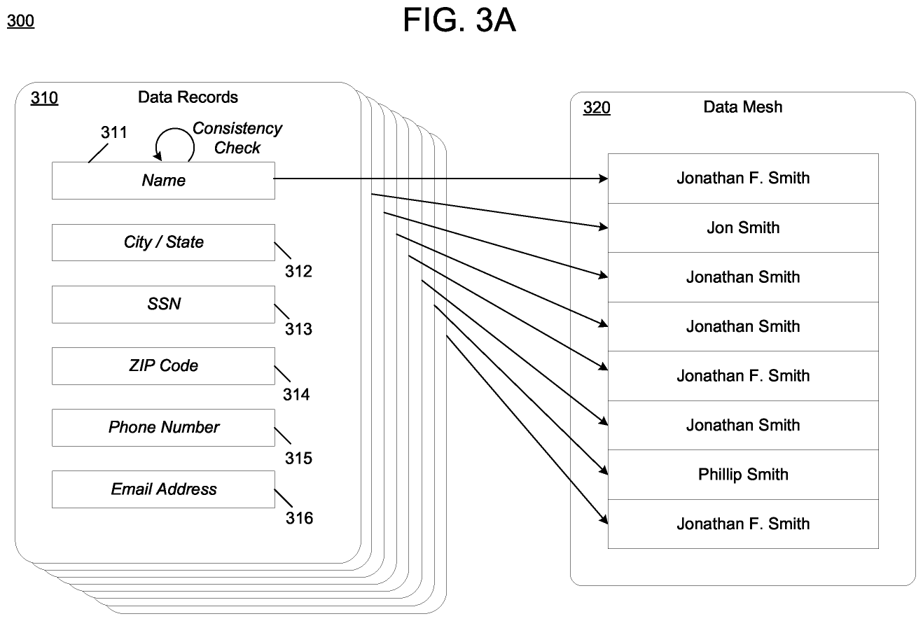

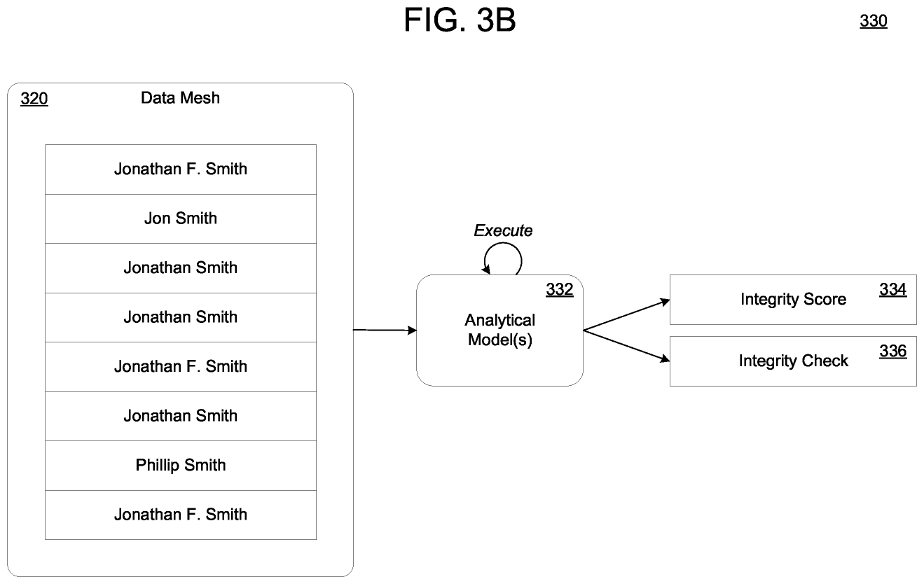

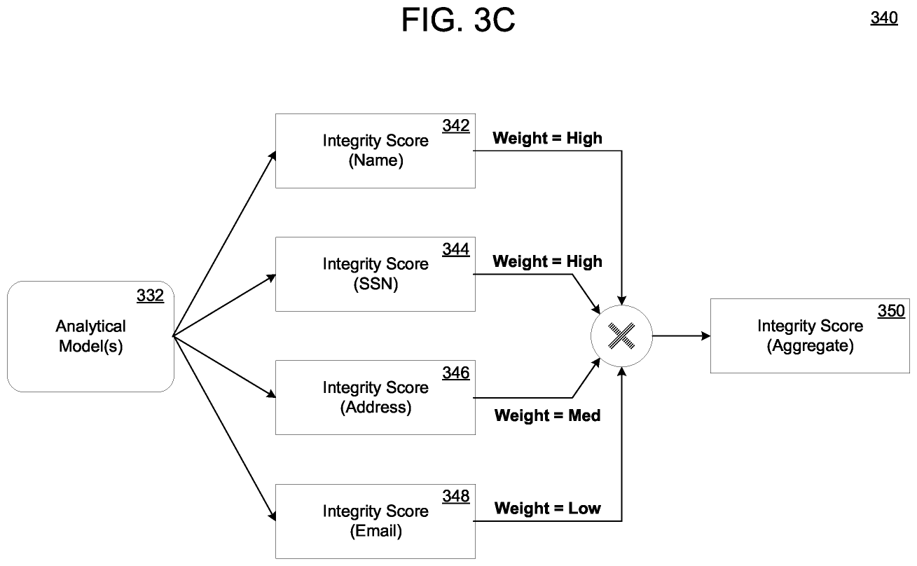

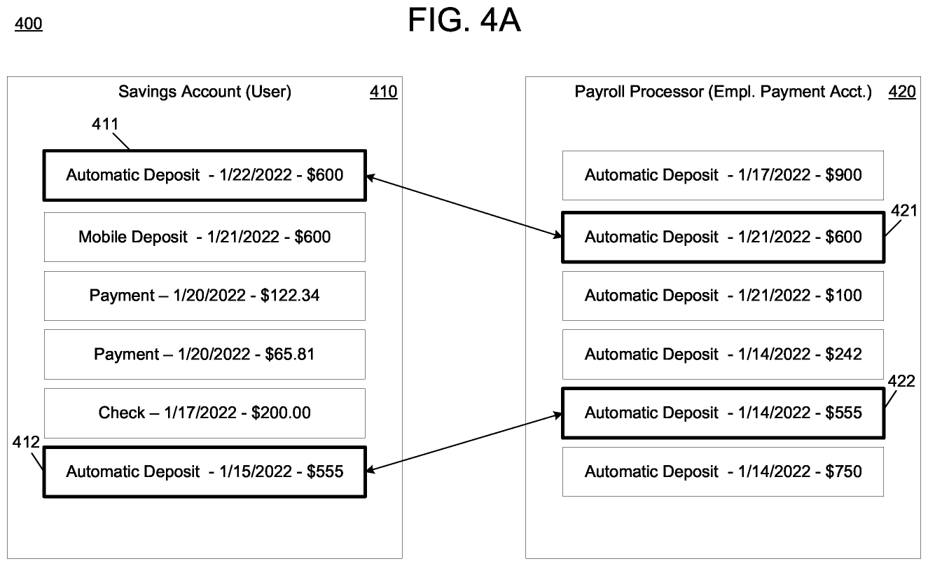

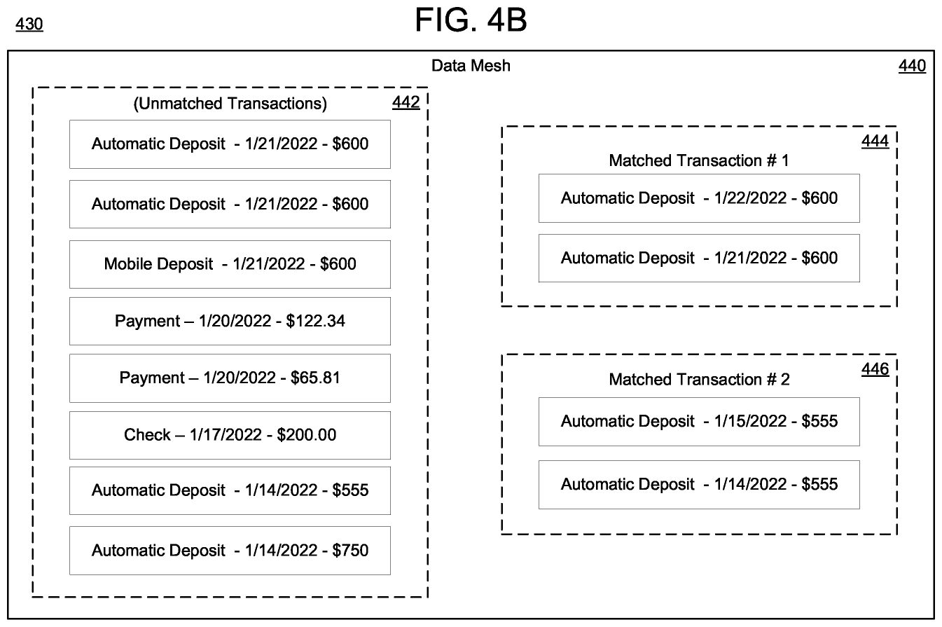

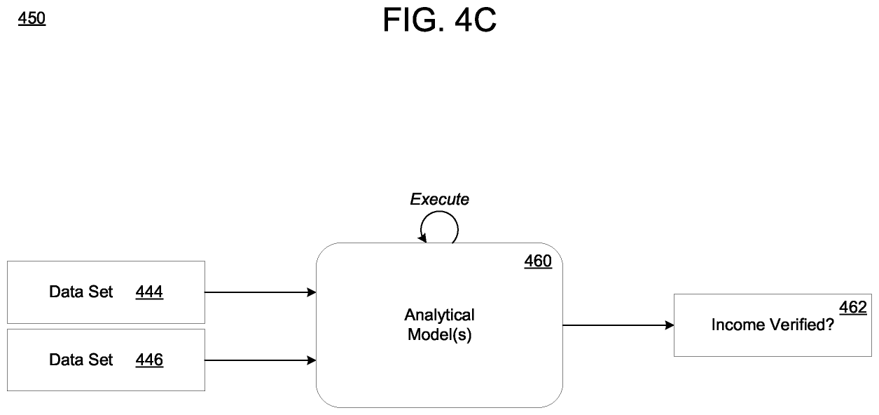

The data ferret 122 may also trigger a reconciliation and deduplication process 126 which identifies duplicate transaction records and deduplicates them in some way, for example, by deleting a duplicate record or some of its content, by consolidating multiple duplicate records into one record, etc. This process can be performed prior to the data ferret 122 performing the unclaimed income source identification process, thereby reducing the number of records needed for consideration by the data ferret 122. As another example, the data ferret 122 may also trigger a fraud analysis 128. This may include one or more of verifying the income of a user, verifying the identity of the user, verifying location of services, and the like. Examples of this process are described with respect to FIGS. 3A-3C and 4A-4C.

The data ferret 122 may temporarily store identifiers of unclaimed sources of income discovered by the data ferret 122. The data ferret 122 may also store indicators of whether the user confirmed the unclaimed sources of income. When the data ferret 122 has completed analyzing the user's transaction history, the data ferret 122 may generate a report 140 or other document that is output to a user device or via a user interface, and in some embodiments the report 140 may also be stored or otherwise retained in a database, blockchain, or the like. The report 140 may include a digital document or other medium with printed information stored therein. The report 140 may identify any unclaimed sources of income that were found by the data ferret 122, user confirmations, and the like.

For completeness, the report 140 can be generated after the data ferret 122 achieves a stopping condition, indicating that income source discovery is complete for this interaction with the user. It should be appreciated that in general, the data ferret 122 can achieve a stopping condition by annotating, updating, and maintaining records for whether it has fully explored the user's income sources, data sources, and the like. As a clarifying example, the data ferret 122 may choose to initialize an empty income source list (not shown in the example embodiments for clarity, but it could exist in transiently memory, in a data store, or the like) to prepare for processing a new user's records. The user may initially connect an income source with identifier “ABC123”, which the data ferret 122 adds to the income source list for this user, and because this income source has not yet been explored at all, this income source would be marked unexplored, such as by using the Boolean value false, an integer value 0, or the like. Simultaneously or sequentially, the data ferret may also link to a third-party seed, which indicates that the user has two income sources with income source identifiers “ABC123” and “XYZ789”. Taking the distinct income sources that have been identified, the data ferret now has a list containing the income sources {“ABC123”: false} and {“XYZ789”: false}. Next, the data ferret could then explore income source “ABC123” as described above, finding a new income source “DEF456”, which it would add to the list as {“DEF456”: false}. After all such new income sources identifiable from income source “ABC123” are found, then the data ferret 122 will update the annotation for income source “ABC123” as {“ABC123”: true} in this example. This iterative process will continue until all income sources in the list are marked as explored, i.e., as marked true in this example. As a clarification regarding a possible edge case, it is possible that the data ferret 122 may run through its processes for prompting the user to link income sources, checking one or more third party data sources, and so on, yet never add an income source to its list of income sources for the user. In this case, a stopping condition could be achieved by exhausting its possible avenues for exploration. In each case, data ferret 122 has iteratively explored the user's income sources by monitoring its list of income sources for the user to determine whether it has explored each income source in an iterative fashion, using software-based annotations to account for whether the individual income sources in the list have been fully explored, and then stopping when all income sources have been iteratively explored, with no further unexplored income source remaining, as well as with no further avenues for exploration. It should be appreciated that the iterative process could apply to discovered income sources, data sources, and the like, and it is not limited to income sources. It should be further appreciated that in the case of existing or otherwise known users, the initial list of income sources, data sources, and the like may be populated by existing information, and that the receipt of new transactions or other data could cause the data ferret 122 to initialize a starting list with known income sources, data sources, and the like, and thus initially mark as being unexplored an existing list, which can further grow through the iterative process.

Instead of relying on the user to find and connect to all of the data sources they believe are relevant, the data ferret 122 collects and identifies high level information that can guide/verify the process. In one example of this implementation, relevant information could be collected from the user such as SSN, address, name, date of birth, etc. This information can be used to obtain third-party data for historic and current information on relevant items such as employers, financial institutions, and other related data. Results might include, but not be limited to, employer or gig platform data, such as employer name, earnings, relevant data such as hire date, departure date, etc. Results might include financial data, such as a financial institution name, financial information such as balances, loan terms, relevant dates such as account open/close dates, additional information on the person, such as addresses, names on file with employers, financial institutions, credit ratings, credit status, fraud flags/warnings, etc. Another example of sourcing third-party data might include having the type of information described passed to the system along with a referred user to help prepopulate that user's profile and help facilitate the collection of supplemental data gathered by the data ferret 122. Also, the collection of the above information is not limited to third parties. For instance, the relevant user data could be used to identify data within an organization's own domain and utilized in ways analogous to those described.

The above process is also not limited to the use of a single data source. By way of example, it could utilize a variety of sources for every user, vary the data sources by user, use some combination of data sources until a predetermined threshold is reached, perform ongoing checks against one or more data sources, and perform supplemental checks as new data sources are added. The data thus collected could further guide the process of connecting to relevant data sources. For example, users might be prompted to connect directly to identified financial institutions, employers, gig accounts, payroll providers, or other relevant data sources identified by the data ferret 122. Such additional connections could provide additional information to the data ferret 122 that might trigger additional prompts in a recursive exercise, resulting in a full exploration of potential income sources.

The workflow sequence point or points where the data ferret 122 can be integrated and perform its associated activities can vary, but examples include at the beginning of the workflow after the user has gone through an initial exercise of connecting relevant data sources on their own, in which case this process acts as a check against the information provided; as a new process triggered by some event, such as access to additional features; with the addition of a new data source; or via a periodic repolling of updated data from such sources after some period of time.

The initial account information and any “claimed” sources of income provided by the user may be considered a “profile seed”. The profile seed may be updated over time (e.g., by adding more sources of income, additional financial accounts, etc.). While the profile seed identifies sources of income data for the user which the data ferret 122 can connect to, the collection of data from those sources enables the data ferret 122 to find and confirm unclaimed sources of income. The data ferret 122 acts as a methodology to identify accounts that need to be connected. It accomplishes this by performing a number of checks on the collected data. It should be noted that the following checks may be greatly enhanced by the ability to clean transactions to identify income sources. It is also important to note that, as each of the processes described leads to new data source connections, the analysis can repeat in an iterative manner as new data is retrieved. Additionally, these processes can be applied to both income and expenses.

For connected income sources from entities such as employers, gig accounts, and payroll accounts, linked financial accounts will be analyzed to find the reconciling transaction as a deposit. If none are found, the user will be prompted to connect to the financial institution where those deposits are received. It is worth noting that if deposits are found for a connected income source, but reconciliation is not possible due to amounts not matching, this could indicate that the income is being split among multiple accounts and could be another indicator that there is a missing financial institution that still needs to be connected.

In a scenario where an income source, such as an employer, has been identified through the process, but the user has not connected to that income source (possibly because such a connection is not supported), identifying deposits from the employer may serve as some level of verification of the appropriate financial institution account connection, even if reconciliation by deposit amount is not possible. Users may proactively specify income sources, for example, if prompted in the workflow to “provide the names of your income sources such as employer name, gig platform, or activity (e.g., babysitting, hair stylist, etc.).” For each of these income sources, the data ferret 122 may prompt the user to either connect directly to the income source, connect to the financial institution where the funds are deposited, or both. The data ferret 122 may attempt to automatically associate any deposits to the income source identified by the user. As a secondary method, the user may have the ability to manually add to each specified income source the associated deposits.

For financial institutions, any transactions that indicate a transfer into or out of the user's account will typically be subject to reconciliation to find the corresponding linked account that balances that transaction. If the system is unable to identify the corresponding linked account, the user will be prompted to connect the account, such as an employer's HR service, etc. For completeness, it's worth mentioning that there may be instances where identified income sources are not able to be verified with connected data sources. One example is where an income source identified by the profile seed has deposits sent to a financial institution the user no longer has access to. In this case, verification of that income can be facilitated through other means. One example might be through the upload of substantiating documentation, such as paystubs. Verification of that information as suitable proof of income is subject to the discretion of the entity employing this invention and can thus vary by the specific embodiment.

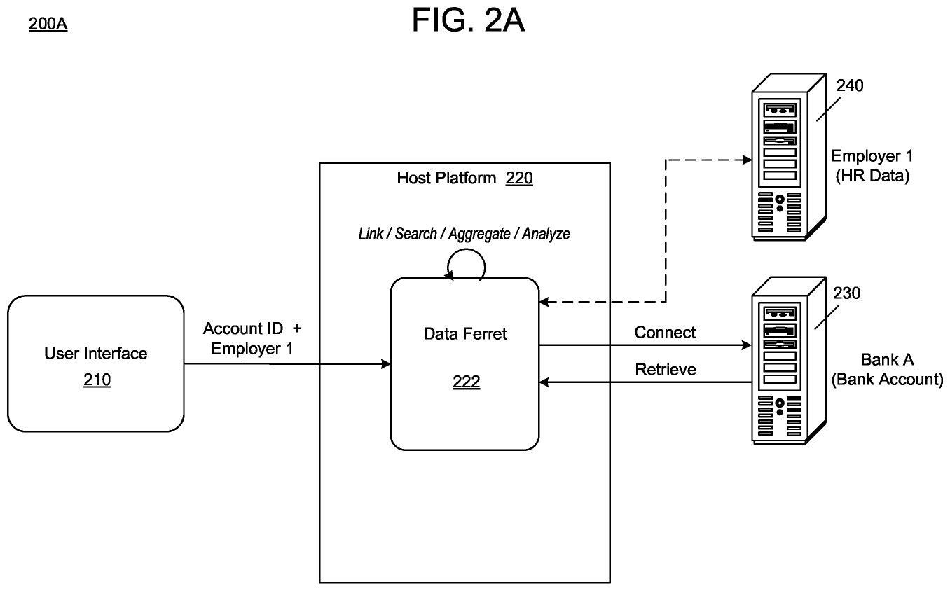

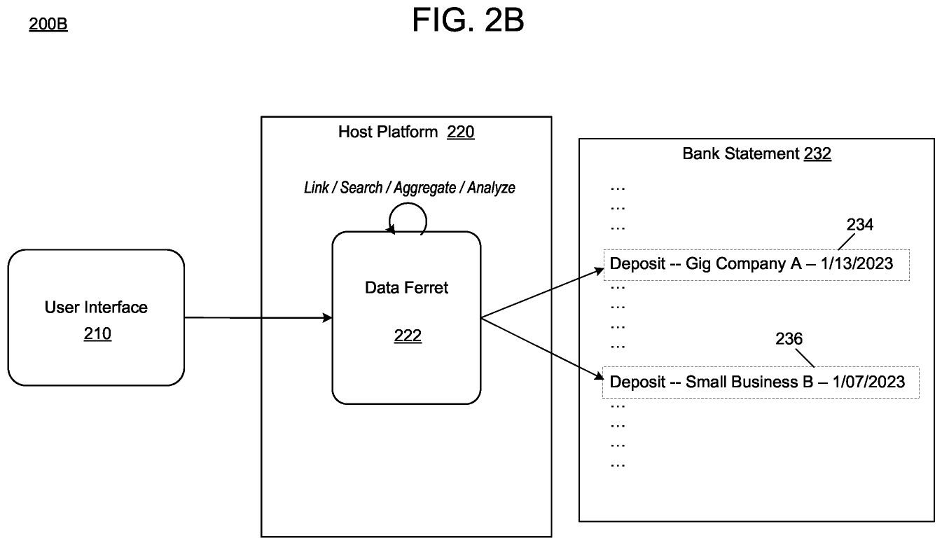

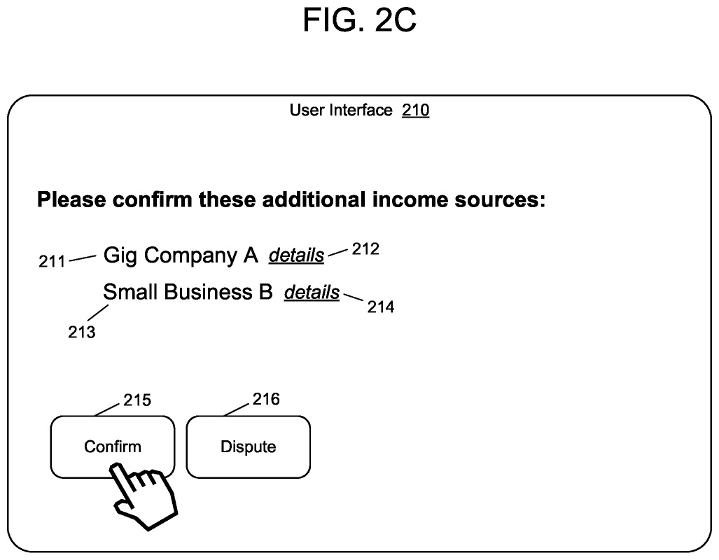

FIGS. 2A-2C illustrate a process of identifying an unclaimed income source in accordance with example embodiments. For example, FIG. 2A illustrates a process 200A of connecting to a third-party data source 230 with access to the user's bank account records at Bank A, based on a profile seed input by a user via a user interface 210. Here, the user interface 210 may be part of a front-end of an application that includes a data ferret 222. The application may be a progressive web application (PWA), a mobile application, a cloud-based application, or the like. The user may enter an account identifier as well as any claimed sources of income. In this example, the user has entered an identifier of an account with Bank A and a source of income of Employer 1. In response, the data ferret 222 may connect to the user's account at Bank A by establishing a secure communication channel between a server of the bank 230 and the host platform 220 where the data ferret 222 is hosted.

Once connected, the data ferret 222 may pull transaction records including bank statements, transaction entries, documents, spreadsheets, account history, and the like, from the bank via the secure communication channel. In some cases, the data ferret 222 may also connect to a server 240 provided by the employer to pull additional data records of the user including payments made to the user such as payment records, paystubs, account history, tax forms, other financial records, etc.

FIG. 2B illustrates a process 200B of the data ferret 222 analyzing a document 232 that is ingested by the data ferret 222 from the user's bank account at Bank A in FIG. 2A. Here, the data ferret 222 detects a recurring deposit 234 from Gig Company A that occurs once a week. The data ferret 222 also detects a recurring deposit 236 from a Small Business B that occurs once a month. The data ferret 222 also contains a list of claimed income sources (i.e., the profile seed, income sources claimed at prior iterations of the data ferret, and the like) or income sources provided by third parties (i.e., the third-party seed). Therefore, the data ferret 222 can compare the identified income sources from the deposit 234 and the deposit 236 to the claimed income sources in the profile seed, third-party seed, and income sources claimed at prior iterations of the data ferret. In this case, neither of these income sources identified from the deposit 234 and the deposit 236 transaction records have been claimed by the user.

FIG. 2C illustrates a display of content within a user interface 210 that may be output by the data ferret 222 upon detecting the unclaimed sources of income in FIG. 2B. Here, the data ferret 222 may display an identifier 211 of a first unclaimed source of income along with a details tab 212, which if clicked on by the user would provide additional details about the unclaimed source of income, which could include full name, merchant type, geographic location, and the like. The data ferret 222 may also display an identifier 213 of a second unclaimed source of income along with a details tab 214. In addition, the data ferret 222 may provide input buttons 215 and 216 (or some other input mechanisms such as sliders, radio boxes, toggles, etc.) for enabling a user to “confirm” such income sources in a tangible way by having to make an entry on the user interface 210. A user's response to this prompt can be recorded and associated with the records for reporting as appropriate. Moreover, depending on the particular embodiment, the user could confirm each of the additional income sources separately or as a group, with capabilities for finalizing the list of claimed income sources.

FIGS. 3A-3C illustrate a process of verifying a user based on personally-identifiable information (PII) in accordance with example embodiments. The process may be performed by a blockchain-enabled peer, for example as explained in the benefit administration processes described in U.S. patent application Ser. No. 17/864,589, filed on Jul. 14, 2022, in the United States Patent and Trademark Office, which is cited above and fully incorporated herein by reference for all purposes, as well as by any other server or host platform mentioned herein. In some embodiments, the host platform may perform a fraud analysis including one or more of a PII consistency check, suspicious data source check, suspicious transaction classification detection, geographic detection, suspicious activity detection, or the like as described in U.S. patent application Ser. No. 17/580,721, filed on Jan. 21, 2022, the entire disclosures of which are incorporated herein by reference for all purposes.

Referring to FIG. 3A, there is shown a process 300 of performing a consistency check on a particular field of PII (i.e., a name value) stored in each of a plurality of data records obtained from multiple sources of truth. Referring to FIG. 3A, a corpus of data records 310 is shown. Here, each of the data records may have some form of PII, such as a name value 311, a city/state value 312, SSN value 313, ZIP Code value 314, phone number value 315, email address value 316, and the like.

In this example, a value for name 311 is separately identified from each (or some relevant sample) of the data records, and these values compared with each other for consistency across records. Here, the corpus of data records 310 can be read by the host platform to identify name values 311 in each of the data records. The name values 311 can be extracted and stored in a table, a file, a document, or the like, and stored together in the same file, record, or other instantiation of a data structure, or the like, within the data mesh 320. If one or more data records do not have a name value, they can be ignored or omitted, or their absence can be considered as part of the consistency checking process and algorithm. In this example, eight (8) name values are identified from PII included in eight different data records where some of the records are from various/differing sources of truth. The name values can be stored in the same file, record, or other instantiation of a data structure, or the like, in the data mesh 320 by the host platform even though they are extracted from different records. It should be further appreciated that in some embodiments, name values can be aggregated by source or account, for example, grouping transaction records to compare names associated with a plurality of different accounts, financial institutions, or the like.

FIG. 3B illustrates a process 330 of analyzing the data mesh 320 including the name values for consistency. In this example, components of the data mesh 320 can be input into one or more analytical models 332, such as a machine learning model, heuristic, or statistical model, which can perform a consistency check. As a non-limiting example, the analytical models 332 may be machine learning models such as fuzzy matching models, similarity assessments, Natural Language Processing (NLP) techniques, or the like. In this example, the purpose of the analytical model 332 is to determine how different/similar the name value is across the different data records. The file with the different name values stored in the data mesh 320 may be vectorized (via converting text-based components or features into a sequence of numeric values, etc.), making it possible for the text to be operated on by a digital computer, including machine learning models, and the like. Here, the name value may refer to just the first name, last name, or a combination of names (including the middle name and/or initial, as well as titles, prefixes, and/or suffixes).

An output of the analytical models 332 may be an integrity score value 334 (e.g., a numeric value in the range of 0 to 100, inclusive, etc.) and an integrity check value 336, which is a Yes/No or True/False value that is determined by comparing the integrity score value 334 to a predetermined threshold for that particular field of PII (i.e., for the name in this example). If above the threshold, the integrity check value 336 is set to Yes/True to indicate a passing check, otherwise its set to No/False. If at the threshold, the integrity check value 336 can arbitrarily be set to provide Yes/True or No/False, depending on the strictness policies for the system. As an additional embodiment of this process, the analytical models 332 may assign different weights to each data record based on factors such as source of data record, with such weighting being determined through means such as manual configuration or dynamic weighting derived from machine learning models tuned to optimize for predictive validity.

This one consistency check may be enough to perform an identity verification. For example, it may be clear after just one consistency check that this user is not who they claim to be. As another example, it may take multiple different values of PII to be considered. FIG. 3C illustrates a process 340 in which an aggregate integrity score 350 is created. Here, the host platform may perform a respective consistency check for multiple different values of PII simultaneously (in parallel) with one another. For example, each consistency check may be performed in parallel by different cores of a multi-core processor or different threads of another execution engine. As another example, the consistency checks may be performed sequentially, one after the other, or otherwise batched or sequenced.

In FIG. 3C, four different integrity scores 342, 344, 346, and 348 are generated for four different fields of PII (i.e., name, SSN, address, and email, respectively) across the corpus of data records from the data mesh. Furthermore, the integrity scores 342, 344, 346, and 348 can be individually weighted differently (if desired, and including the possibility of zero-valued weights) and then aggregated together and potentially normalized to a predetermined scale by a function or model to create the aggregated integrity score 350. This aggregated integrity score 350 can be used to make a final decision on whether the identity of the user is verified or whether it is not.

Based on one or more integrity scores, the back-end of the software application may make a decision of Yes or No that the identity is verified. This information may be used to modify or otherwise annotate via reference to the original corpus of data records in the data mesh to include a value for such a decision. As another example, the identity verification process result, such as one or more of the integrity scores, may be an input into a decision by the back-end of the software application on whether to activate a new account with the software application based on the identity verification determination. Here, the host platform may only activate the account when the integrity score and/or integrity check values satisfy predefined thresholds. If so, the activation may enable the user to participate in the software application as an active user. This may give the user rights to send messages to other users of the software application, create an account profile, browse web listings, browse employment opportunities, prepare benefit-related applications, and the like.

FIGS. 4A-4C illustrate a process of verifying income-based records in accordance with example embodiments. The process may be performed during the income source verification process performed by the host platform shown in FIG. 1A. As an example, FIG. 4A illustrates a process 400 of comparing partially overlapping transaction records from data sets 410 and 420, respectively. In this example, the transaction data sets 410 and 420 are from two different financial accounts which could be a claimed income source or an unclaimed income source compared to payments stored within a user's bank account. In the example of FIG. 4A, the user's bank account and a payroll processor payment account associated with the user's employer are compared, respectively. In some embodiments, the host platform may perform one or more of a transaction string cleaning process as described in U.S. patent application Ser. No. 17/342,622, filed on Jun. 9, 2021, in the United States Patent and Trademark Office, a transaction string cleaning process as described in U.S. patent application Ser. No. 17/867,958, filed on Jul. 19, 2022, in the United States Patent and Trademark Office, and a transaction reconciliation and deduplication process as described in U.S. patent application Ser. No. 17/835,044, filed on Jun. 8, 2022, in the United States Patent and Trademark Office, the entire disclosures of which are incorporated herein by reference for all purposes.

In the example of FIG. 4A, the host platform detects that a transaction 411 in the user's savings account matches/corresponds to a transaction 421 in the payment account of the payroll processor. Likewise, a transaction 412 in the user's savings account corresponds to a transaction 422 in the payment account of the payroll processor. In other words, the host platform detects that two transaction records within account summaries of the two accounts hosted by the trusted sources correspond to each other (i.e., they are from the same financial transaction). In this case, the two accounts may be the opposite sides (i.e., counterparties) of a financial transaction (e.g., payor and payee). As another example, both accounts may be user accounts and the corresponding transaction records may be duplicates or copies with differences that result from the different financial entities processing the transactions.

Based on the results of the detection process, the host platform may create different files or records within the data mesh as shown in the process 430 of FIG. 4B. In this example, the host platform generates three data sets including an unmatched transaction data set 442, a first matched transaction data set 444, and a second matched transaction data set 446, within data mesh 440 of the host platform. It should be appreciated that in some embodiments, matched transactions may be grouped together into their respective income sources, as a convenience for the user. Moreover, this grouping together process can be iteratively performed, incorporating additional income sources when claimed.

Thus, the host platform of the example embodiments is able to read through or otherwise process transaction data sets from different trusted sources and identify common/linked transactions between two or more transaction data sets. In other words, the host platform identifies transactions that overlap and/or otherwise correspond. This redundancy and/or correspondence can be used for verification purposes as noted by the above-incorporated patent applications. It should be noted that sources of information could also include manually uploaded documents that are processed via OCR or the like, and that may not have the same level of trust or integrity. Naturally, the fraud prevention capabilities mentioned above in relation to these embodiments still could apply.

FIG. 4C illustrates a process 450 of processing the second and third data sets 444 and 446, respectively, from the data mesh via an analytical model 460. An output 462 of the analytical model 460 could be a determination of whether the transactions are indeed income related, whether the income attributed to the transactions is verified, or the like. In the case of output 462, the output is a determination of whether or not income is verified. For example, the output 462 may include a score, a Yes/No evaluation or other binary value, and the like. The host platform may clean the data in the data mesh so that other parts of the system or systems can access and process the data as desired (e.g., via fraud detection and income verification, or another combination of verification platform assessments and/or checks, and the like). FIG. 4C can be seen to represent how the income verification process can combine all the pieces together to deliver an output. For example, the process might use PII/Identity Verification with certain thresholds, perform Transaction Integrity Checks with other thresholds, and decide to not use geographic verification, etc., depending on the goals of the particular embodiment of this system.

Prior to and/or during the income verification process described in the examples of FIGS. 4A-4C, the host platform may also enhance the transaction records through a process referred to as transaction string cleaning. The transaction strings contained in the transaction records can be analyzed to identify additional details of the transaction that are not expressly present in the transaction record or the transaction string, including counterparty names, geographic location, transaction types, transaction classifications, etc.

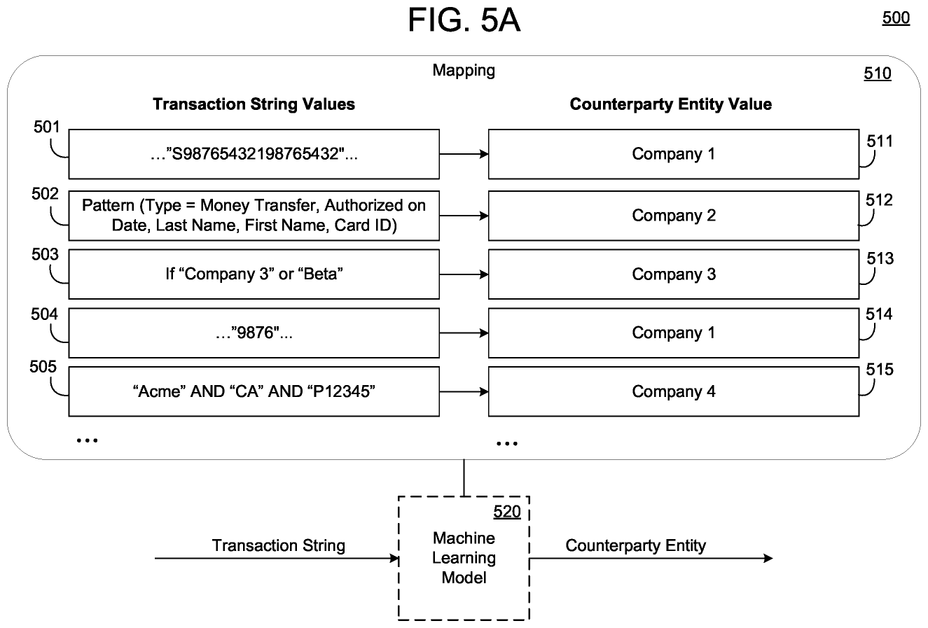

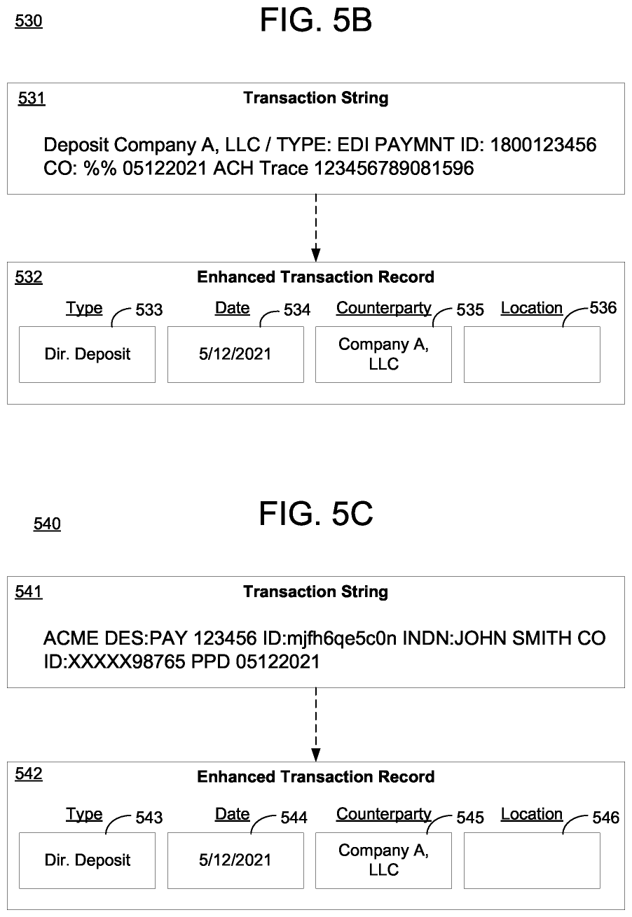

FIG. 5A illustrates a process 500 of mapping transaction strings from transaction records to counterparty entities via a machine learning model 520 in accordance with an example embodiment. As an example, the process 500 may be performed to identify unclaimed sources of income as described herein. In this example, a counterparty refers to a party of the transaction (e.g., a payor, etc.) when viewed from a transaction record of another party to the transaction (e.g., a payee, etc.). In the example embodiments, a “payor” is a possible source of income. If unclaimed, then the payor would be an “unclaimed” source of income.

According to various embodiments, the payee may have an account summary with transaction records including payments from the payor who is the counterparty to the payee's transaction record. Likewise, the payee is the counterparty to the payor's transaction record. The transaction strings corresponding to those financial transactions may not expressly list the name of the counterparty or may list content that cannot be understood easily by a human nor that can easily be mapped to a counterparty by a human. The transaction string cleaning process may identify such counterparty based on machine learning and use that data when performing the income verification to further enhance the results of the verification process (i.e., to make them more accurate, etc.).

Referring to FIG. 5A, a host platform such as a server or blockchain-enabled peer may store the machine learning model 520 (or otherwise call the machine learning model 520 if embodied as an external program or service from the server, blockchain-enabled peer, or the like). Here, the machine learning model 520 may be trained from known mappings to learn mapping relationships between various components of transaction strings 501, 502, 503, 504, and 505 and corresponding counterparty entities 511, 512, 513, 514, and 515, respectively, based on historical mappings which may be manually entered or previously mapped by the machine learning model 520. It should also be appreciated that other aspects of the transaction record (besides the transaction string or in addition to the transaction string) may be mapped to a counterparty entity. For example, a transaction type, other transaction data, geographical location, etc. may be used to map a transaction record to a counterparty. That is, mappings predicted by the machine learning model 520, which may be confirmed first by a user or a host, may be used to retrain the machine learning model 520, thus creating training improvements from the operating data created by the host platform.

In some embodiments, the machine learning model 520 may be a neural network or the like designed for the task of named entity recognition, which in this case classifies each word in a transaction string as part of a counterpart entity name, or not. The neural network or alternative machine learning algorithm may reason this by observing word placement and linguistic dependencies formed by other words in the transaction string. Accordingly, the machine learning model 520 is able to generalize over any transaction string format, as there are numerous possible formats that hard-coded rules would miss. In many embodiments, the only data passed to the machine learning model 520 to make a prediction is the transaction string itself. Of course, some embodiments could include heuristics and/or rules, which may result from or otherwise inform, modify, and/or enhance machine learning models. Also, other embodiments could further include other transaction metadata typically contained in transaction records, such as transaction type, transaction amount, etc.

In some embodiments, the input may be the transaction string and the output may be the same data structure (e.g., document, file, table, spreadsheet, etc.) in which the transaction string is input with one or more additional values added including the identified counterpart entity and possibly other data such as date, location, transaction type, and the like. In this way, the translation service may modify the input file to include a value or multiple values within a data structure thereof, which makes it more helpful for processing by an additional analytics service.

FIGS. 5B and 5C illustrate processes 530 and 540, respectively, of translating a transaction string into a counterparty entity value in accordance with example embodiments. Referring to FIG. 5B, a transaction string 531 may be input to the host system (e.g., a blockchain-enabled peer, a server, etc.), and the output may be the enhanced transaction data record 532. The enhanced transaction data record 532 may include a plurality of fields 533, 534, 535, and 536 for storing data values that are extracted, identified, and/or inferred from the transaction string 531, or from the initial input transaction record associated with the raw transaction string that may have been received from a particular data source. Here, the translation service may identify the counterparty entity as “Company A, LLC”, whose name is explicitly recited within a transaction string 531. In addition, the translation service may identify additional details such as a type of the transaction, a transaction classification (e.g., a reason, explanation, category, or the like), a date of the transaction, a geographic location, or the like. However, in this example, since this is a direct deposit type of transaction, there is no geographic location specified in the enhanced transaction record 532. The resulting data values that are identified by the translation service may be stored within data fields 533, 534, and 535 of the enhanced transaction record 532, while the data field 536 may be left blank or empty.

FIG. 5C illustrates another example of identifying the counterparty entity. Here, a transaction string 541 is input to the host system and an enhanced transaction data record 542 is output. The enhanced transaction data record 542 includes a plurality of fields 543, 544, 545, and 546 for storing data values that are identified and/or inferred from the transaction string 541. Unlike the example in FIG. 5B, in the example of FIG. 5C, the counterparty entity “Company A, LLC” is not expressly listed by name within the transaction string 541. Instead, a payroll processor name (Acme) of the employer is listed within the transaction string. In this example, the machine learning model 520 (shown in FIG. 5A) may be executed on the transaction string 541 to implicitly map one or more substrings within the transaction string 541 to the counterpart entity name (Company A, LLC). For example, the combination of substrings “Acme”, “John Smith” and “8765” may be mapped to the name of “Company A, LLC” by the machine learning algorithm, for example as part of a multi-class classification algorithm; it should be appreciated that the machine learning classifier could also be constructed in the form of an ensemble of machine learning models, e.g., performing a classification. The resulting data values that are identified by the translation service may be stored within the data fields 543, 544, and 545, while the data field 546 may be left empty or blank, since there is not a clear geographic location of the direct deposit. However, the host platform may fill in or otherwise specify or approximate values for the location fields 536 and/or 546, should the geographic location of the user be identified from the transaction records, including the transaction string and other information included in the transaction records.

In addition to enhancing the transaction records, the host platform described herein may “reconcile” transaction records prior to and/or during the income verification process described in FIGS. 4A-4C. The reconciliation process may identify matching transaction records such as two transactions from balancing or opposing sides of the same transaction and duplicate transaction records from the same side of the transaction. This process may be used to reduce the total number of transaction records that are processed by the income verification process. Furthermore, the process may identify “balancing” transactions that represent two sides of the same transaction. These “balanced” transactions can be used to verify that the same amount of money that was sent to a person was the same amount of money that was deposited. This can also be used to confirm that income was sent and received.

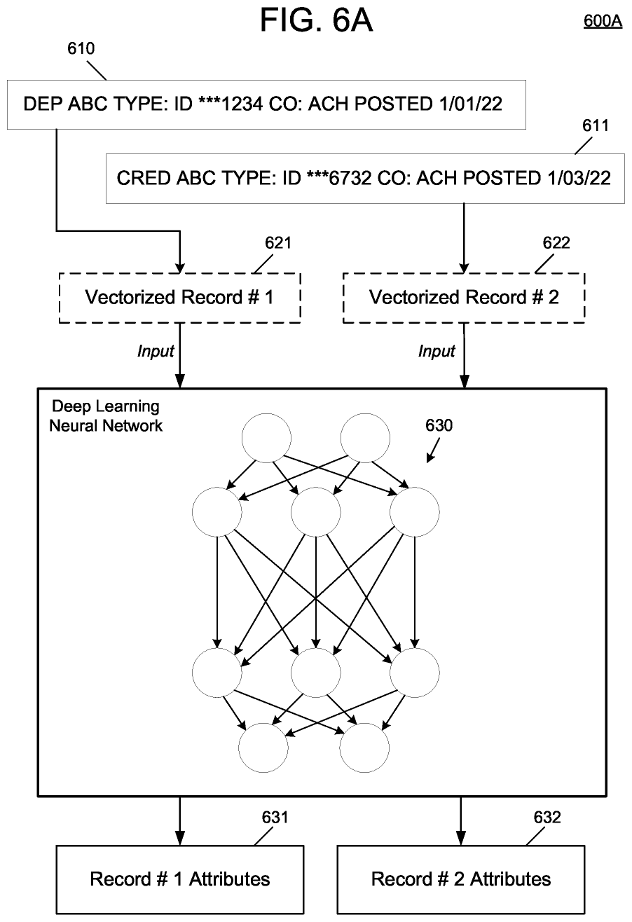

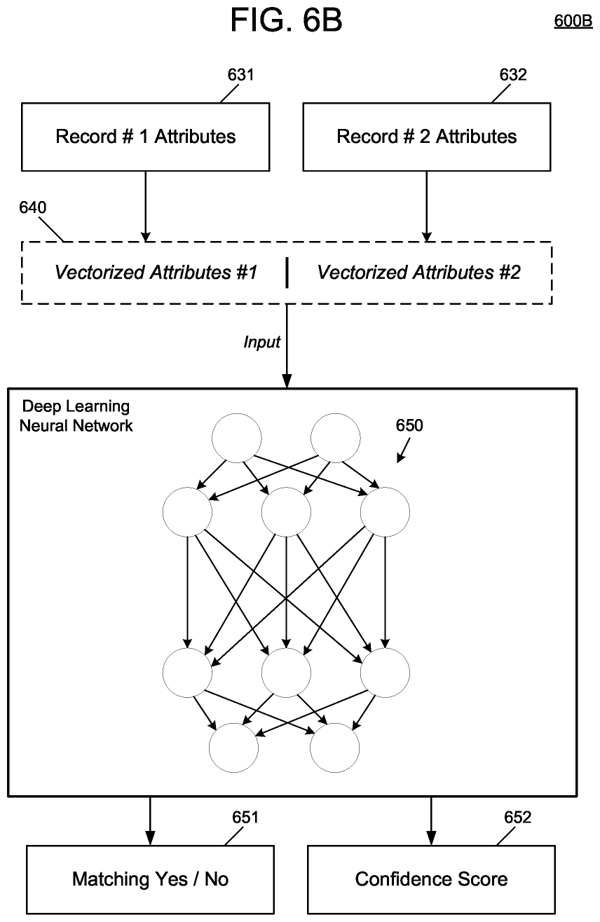

FIGS. 6A and 6B illustrate an example of two machine learning processes that are performed by two machine learning models that work in sequence to identify duplicate transactions among different sources of transaction strings. However, it should be appreciated that both processes may be performed at the same time by the same machine learning model. In other words, the examples of FIGS. 6A and 6B are not meant to limit the possible use of machine learning by the example embodiments, but merely for purposes of example. Also, the machine learning models described herein may be integrated within a larger machine learning service that is also hosted by the host platform and that can be accessed via application programming interface (API) calls or the like, on the host platform. For example, an API call may specify a particular type of machine learning model to execute from among a plurality/catalogue of machine learning models, heuristics, and/or machine-learning-generated/informed heuristics. The API call may also include the input data (such as the transaction string, transaction record, etc.) to be processed by the machine learning model/service.

FIG. 6A illustrates a process 600A of a machine learning model identifying transaction attributes from a transaction record in accordance with an example embodiment. FIG. 6B illustrates a process 600B of a machine learning model matching together two transaction records based on the transaction attributes identified in FIG. 6A, in accordance with an example embodiment. As described in these examples, the transaction “attributes” may be considered to be concrete values for transaction “parameters” described herein throughout. Both processes may be executed by the host platform (e.g., a blockchain-enabled peer, a web server, etc.).

Referring to FIG. 6A, the host platform may select two transaction records 610 and 611 from two different digital documents (e.g., two different bank statements, etc.), from records in a data pull spanning a range of dates not necessarily corresponding to statement periods, etc. These two transaction records 610 and 611 may be processed to identify whether these two transaction representations reconcile to the same transaction. Here, the transaction records 610 and 611 are converted into vectors 621 and 622, respectively. The vectorization process may be performed by any known techniques, including natural language processing (NLP), topic modeling, recurrent modeling, bag of words, bag of n-grams, or the like. By converting the contents of the transaction records, which may contain text and other content, into vectors (numerical content), the data can now be input/entered into a machine learning model 630, such as a deep learning neural network or the like.

In response, the machine learning model 630 may identify respective attributes in each of the transaction records. The machine learning model may output transaction attributes 631 identified by the machine learning model 630 from the transaction record 610 and transaction attributes 632 identified by the machine learning model 630 from the transaction record 611. Transaction attributes may include one or more of a transaction amount, a transaction date, a counterparty entity, a geographical location, and the like. In some cases, no attributes may be identified.

Next, the process 600B may be used to identify whether these two transaction records 610 and 611 reconcile/match a same transaction. Here, the transaction attributes 631 and 632 may be vectorized into a single vector 640 or multiple vectors, and input into a machine learning model 650, which may or may not be a deep learning neural network, other supervised learning model or the equivalent, or any of the other matching models described herein. In response, the machine learning model 650 may output a determination 651 indicating whether or not the two transaction records reconcile to a same transaction and a confidence score 652, indicating a confidence of the prediction (e.g., an accuracy, likelihood, etc.).

When determining whether a user is eligible for a benefit, such as a benefit offered by a basic income benefits program, the host platform may perform one or more of an identity verification, an income verification, a fraud detection, and the like, which are described herein as part of the eligibility verification of a user. The host may also retrieve criteria/qualifications of the benefits program that the user wishes to be certified with and determine whether or not the user qualifies for the benefits program based on the retrieved criteria and user-specific data, such as income data and other data of the user, which may be primarily obtained from authorized accounts of the user.

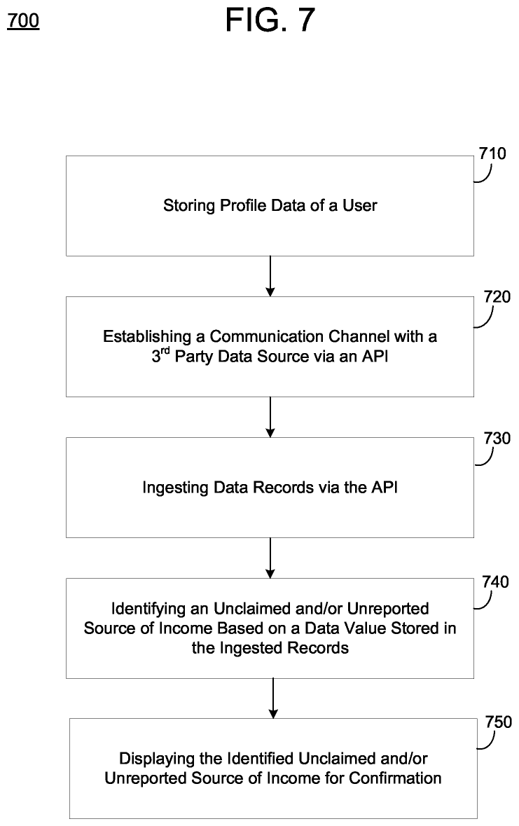

FIG. 7 illustrates a method 700 of eligibility verification and automated benefit distribution in accordance with an example embodiment. For example, the method 700 may be performed by the host platform described herein such as a cloud platform, a web server, a database, a distributed system, and the like. Referring to FIG. 7, in 710, the method may include storing, via a storage device, profile data of a user which includes one or more claimed sources of income and an account identifier of a payment account of the user with a third-party data source.

In 720, the method may include establishing a communication channel with the third-party data source via an application programming interface (API). In 730, the method may include ingesting data records of the user from the third-party data source via the established communication channel based on the account identifier. In 740, the method may include identifying an unclaimed or otherwise unreported source of income based on data stored within the ingested data records. For example, partial string values within transaction strings may be used by the host platform to identify a counterparty (i.e., a payor) of credit to the user's payment account. Such payment, when detected from a business, organization, etc., may be identified as a potential income source. In 750, the method may include displaying, via a software application, a user interface with an identifier of the unclaimed or otherwise unreported source of income and an input mechanism which is configured to confirm the identified unclaimed source of income based on user input.

In some embodiments, the ingesting may include ingesting one or more documents from a user device via the software application, and identifying the one or more claimed sources of income and the account identifier from content stored within the one or more documents. In some embodiments, the identifying may include identifying the unclaimed source of income from one or more of a transaction string and a counterparty identity included in a data record of a credit transaction from among the ingested data records of the user. In some embodiments, the method may further include executing a machine learning model on data values extracted from the ingested data records to identify a counterparty entity of a financial transaction included in the ingested data records. In some embodiments, the identifying may include identifying the counterparty entity as the unclaimed source of income.

In some embodiments, the method may further include identifying duplicate financial transactions within the retrieved financial transactions, and removing data records of the duplicate financial transactions from the ingested data records prior to identifying one or more unclaimed sources of income. In some embodiments, the method may further include extracting a value of a target data point from each data record of a set of data records to obtain a set of extracted values of the user for the target data point, respectively, and determine consistency of the value of the target data point for the user across the set of data records. In some embodiments, the method may further include determining whether or not the user is verified based on the consistency of the target data point of the user across the set of data records, and display an indication of whether the user is verified via the user interface of the software application.

The above embodiments may be implemented in hardware, in a computer program executed by a processor, in firmware, or in a combination of the above. A computer program may be embodied on a computer-readable medium, such as a storage medium or storage device. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

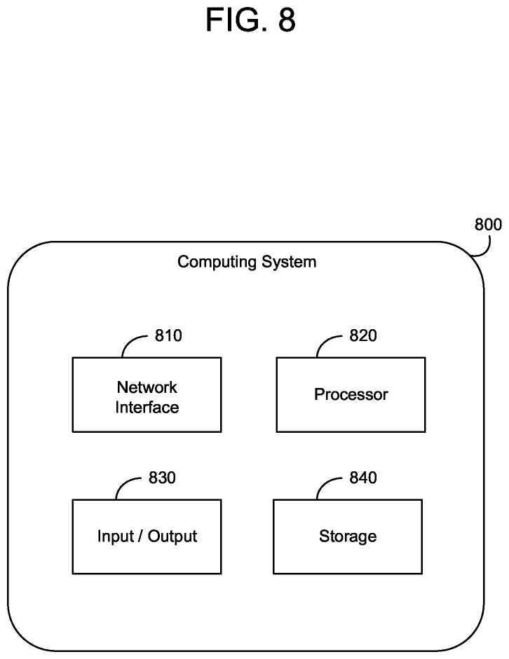

A storage medium may be coupled to the processor such that the processor may read information from, and write information to, the storage medium. In an alternative, the storage medium may be integral to the processor. The processor and the storage medium may reside in an application-specific integrated circuit (“ASIC”). In an alternative, the processor and the storage medium may reside as discrete components. For example, FIG. 8 illustrates an example computing system 800 which may process or be integrated in any of the above-described examples, etc. FIG. 8 is not intended to suggest any limitation as to the scope of use or functionality of embodiments described herein. The computing system 800 is capable of being implemented and/or performing any of the functionality set forth hereinabove.

The computing system 800 may include a computer system/server, which is operational with numerous other general-purpose or special-purpose computing system environments or configurations. Examples of well-known computing systems, environments, and/or configurations that may be suitable for use as computing system 400 include, but are not limited to, personal computer systems, server computer systems, thin clients, thick clients, hand-held or laptop devices, tablets, smart phones, databases, multiprocessor systems, microprocessor-based systems, set top boxes, programmable consumer electronics, network PCs, minicomputer systems, mainframe computer systems, distributed cloud computing environments, databases, and the like, which may include any of the above systems or devices, and the like. According to various embodiments described herein, the computing system 800 may be, contain, or include a tokenization platform, server, CPU, or the like.

The computing system 800 may be described in the general context of computer system-executable instructions, such as program modules, being executed by a computer system. Generally, program modules may include routines, programs, objects, components, logic, data structures, and so on that perform particular tasks or implement particular abstract data types. The computing system 800 may be practiced in distributed cloud computing environments where tasks are performed by remote processing devices that are linked through a communications network. In a distributed cloud computing environment, program modules may be located in both local and remote computer system storage media including memory storage devices.

Referring to FIG. 8, the computing system 800 is shown in the form of a general-purpose computing device. The components of computing system 800 may include, but are not limited to, a network interface 810, a processor 820 (or multiple processors/cores), an input/output 830, which may include a port, an interface, etc., or other hardware, for receiving a data signal from another device, or for outputting a data signal to another device such as a display, a printer, etc., and a storage device 840, which may include a system memory, or the like. Although not shown, the computing system 800 may also include a system bus that couples various system components, including system memory to the processor 820.

The storage 840 may include a variety of computer system readable media. Such media may be any available media that is accessible by computer system/server, and it may include both volatile and non-volatile media, removable and non-removable media. System memory, in one embodiment, implements the flow diagrams of the other figures. The system memory can include computer system readable media in the form of volatile memory, such as random-access memory (RAM) and/or cache memory. As another example, storage device 840 can read and write to a non-removable, non-volatile magnetic media (not shown and typically called a “hard drive”) and/or a solid state drive (SSD). Although not shown, a magnetic disk drive for reading from and writing to a removable, non-volatile magnetic disk (e.g., a “floppy disk”), an optical disk drive for reading from or writing to a removable, non-volatile optical disk such as a CD-ROM, DVD-ROM or other optical media, and/or a flash drive, such as USB drive or an SD card reader for reading flash-based media, can be provided. In such instances, each can be connected to the bus by one or more data media interfaces. As will be further depicted and described below, storage device 840 may include at least one program product having a set (e.g., at least one) of program modules that are configured to carry out the functions of various embodiments of the application.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module”, or “system.” Furthermore, aspects of the present application may take the form of a computer program product embodied in one or more computer readable medium(s) having computer readable program code embodied thereon.

Although not shown, the computing system 800 may also communicate with one or more external devices such as a keyboard, a pointing device, a display, etc.; one or more devices that enable a user to interact with computer system/server; and/or any devices (e.g., network card, modem, etc.) that enable computing system 800 to communicate with one or more other computing devices. Such communication can occur via I/O interfaces. Still yet, computing system 800 can communicate with one or more networks such as a local area network (LAN), a general wide area network (WAN), and/or a public network (e.g., the Internet) via network interface 810. As depicted, network interface 810 may also include a network adapter that communicates with the other components of computing system 800 via a bus. Although not shown, other hardware and/or software components could be used in conjunction with the computing system 800. Examples include, but are not limited to: microcode, device drivers, redundant processing units, external disk drive arrays, RAID systems, tape drives, and data archival storage systems, etc.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described regarding specific examples, it should be understood that various changes, substitutions, and alterations apparent to those skilled in the art can be made to the disclosed embodiments without departing from the spirit and scope of the disclosure as set forth in the appended claims.

1. A computing system comprising:
a data store configured to store profile data of a user which includes one or more claimed sources of income and an account identifier of a financial account of the user with a third-party data source; and
a processor configured to
establish a communication channel with the third-party data source via an application programming interface (API),
ingest data records of the user from the third-party data source via the established communication channel based on the account identifier,
identify an unclaimed source of income based on data stored within the ingested data records,
display, via a software application, a user interface with an identifier of the unclaimed source of income and an input mechanism which is configured to confirm the identified unclaimed source of income based on user input, and
repeat the identifying and the displaying until a stopping condition is achieved.

2. The computing system of claim 1, wherein the processor is configured to ingest one or more documents from a user device via the software application, and identify the unclaimed source of income from content stored within the one or more documents.

3. The computing system of claim 1, wherein the processor is configured to identify the unclaimed source of income from one or more of a transaction string, transaction date, transaction amount, and a counterparty identity included in a data record of a credit transaction from among the ingested data records of the user.

4. The computing system of claim 1, wherein the processor is configured to execute a machine learning model on data values extracted from the ingested data records to identify a counterparty entity of a financial transaction included in the ingested data records.

5. The computing system of claim 4, wherein the processor is configured to identify the counterparty entity as the unclaimed source of income.

6. The computing system of claim 1, wherein the processor is configured to identify duplicate financial transactions within the retrieved financial transactions, and remove data records of the duplicate financial transactions from the ingested data records prior to identifying the one or more unclaimed sources of income.

7. The computing system of claim 1, wherein the processor is configured to extract a value of a target data point from each data record of a set of data records to obtain a set of extracted values of the user for the target data point, respectively, and determine a consistency of the value of the target data point across the set of data records.

8. The computing system of claim 7, wherein the processor is further configured to determine whether the user is verified based on the determined consistency of the target data point across the set of data records, and display an indication of whether the user is verified via the user interface of the software application.

9. A method comprising:
storing, via a storage device, profile data of a user which includes one or more claimed sources of income and an account identifier of a financial account of the user with a third-party data source;
establishing a communication channel with the third-party data source via an application programming interface (API);
ingesting data records of the user from the third-party data source via the established communication channel based on the account identifier;
identifying an unclaimed source of income based on data stored within the ingested data records;
displaying, via a software application, a user interface with an identifier of the unclaimed source of income and an input mechanism which is configured to confirm the identified unclaimed source of income based on user input; and
repeating the identifying and the displaying until a stopping condition is achieved.

10. The method of claim 9, wherein the ingesting comprises ingesting one or more documents from a user device via the software application, and the identifying comprises identifying the unclaimed source of income from content stored within the one or more documents.

11. The method of claim 9, wherein the identifying comprises identifying the unclaimed source of income from one or more of a transaction string, transaction date, transaction amount, and a counterparty identity included in a data record of a credit transaction from among the ingested data records of the user.

12. The method of claim 9, wherein the method further comprises executing a machine learning model on data values extracted from the ingested data records to identify a counterparty entity of a financial transaction included in the ingested data records.

13. The method of claim 12, wherein the identifying comprises identifying the counterparty entity as the unclaimed source of income.

14. The method of claim 9, wherein the method further comprises identifying duplicate financial transactions within the retrieved financial transactions, and removing data records of the duplicate financial transactions from the ingested data records prior to identifying the one or more unclaimed sources of income.

15. The method of claim 9, wherein the method further comprises extracting a value of a target data point from each data record of a set of data records to obtain a set of extracted values of the user for the target data point, respectively, and determine a consistency of the value of the target data point for the user across the set of data records.

16. The method of claim 15, wherein the method further comprises determining whether or not the user is verified based on the consistency of the target data point of the user across the set of data records, and display an indication of whether the user is verified via the user interface of the software application.

17. A non-transitory computer-readable medium comprising instructions which when executed by a computer cause a processor to perform a method comprising:
storing, via a storage device, profile data of a user which includes one or more claimed sources of income and an account identifier of a financial account of the user with a third-party data source;
establishing a communication channel with the third-party data source via a an application programming interface (API);
ingesting data records of the user from the third-party data source via the established communication channel based on the account identifier;
identifying an unclaimed source of income based on data stored within the ingested data records;
displaying, via a software application, a user interface with an identifier of the unclaimed source of income and an input mechanism which is configured to confirm the identified unclaimed source of income based on user input; and
repeating the identifying and the displaying until a stopping condition is achieved.

18. The non-transitory computer-readable medium of claim 17, wherein the ingesting comprises ingesting one or more documents from a user device via the software application, and the identifying comprises identifying the unclaimed source of income from content stored within the one or more documents.

19. The non-transitory computer-readable medium of claim 17, wherein the identifying comprises identifying the unclaimed source of income from one or more of a transaction string and a counterparty identity included in a data record of a credit transaction from among the ingested data records of the user.

20. The non-transitory computer-readable medium of claim 17, wherein the method further comprises executing a machine learning model on data values extracted from the ingested data records to identify a counterparty entity of a financial transaction included in the ingested data records.
